(19) United States
(12) Patent Application Publication
(10) Pub. No.: US 2006/0038608 A1
(43) Pub. Date: Feb. 23, 2006

(54) Band-gap circuit

(76) Inventor: Katsumi Ozawa, Atsugi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/921,808

(22) Filed: Aug. 20, 2004

(51) Int. Cl. G05F 1/10

(52) U.S. Cl. 327/539

(57) ABSTRACT

A band-gap circuit is constituted by comprising a feedback control amplifier 31 and MOS transistors 32 and 35, having two transistors 33 and 34 of which emitter area is different, comprising resistors R₁, R₂ and Rₚ between a base and an emitter of the transistor 33 of which emitter area is smaller, having the resistor Rₚ between the base and a collector and comprising the resistors R₁ and R₂ between the base and emitter of the transistor 34 of which emitter area is larger. It is possible to provide the band-gap circuit operable at a low supply voltage and having high PSRR, low noise and few variations.

### FIELD OF THE INVENTION

The present invention relates to a band-gap circuit for generating and outputting a reference voltage, and in particular, to the band-gap circuit of high PSRR, low noise and few voltage variations which outputs the reference voltage of a low voltage proportional to a band-gap voltage and having no temperature dependence so as to allow low supply voltage operation.

### BACKGROUND OF THE INVENTION

Conventionally, a band-gap circuit has been known as a circuit for generating a reference voltage having no temperature dependence. The band-gap voltage generated by the band-gap circuit is 1.2V or so under normal circumstances. However, Japanese Patent Application Laid-Open No. 2002-318626 discloses the band-gap circuit of 0.5V or so as the band-gap circuit operable at low supply voltage. As shown in FIG. 1, it creates, in different circuit blocks, a PTAT (Proportional To Absolute Temperature) current having a characteristic proportional to an absolute temperature at a positive gradient and a CTAT (Complementary To Absolute Temperature) current having a characteristic dependent on the absolute temperature at a negative gradient, respectively. These currents are added to generate the current having no temperature dependency, and the current is passed through a resistance of an output portion so as to convert the current to a voltage and create a low reference voltage having no temperature dependence.

In such a circuit, a current source transistor is operable even in the case of a low supply voltage. In the case of this circuitry, two feedback control amplifiers and five current paths are required.

The band-gap circuit wherein the PTAT current and CTAT current are created in the same current path and the low reference voltage is thereby created with only one feedback control amplifier and three current paths is shown in “Hirofumi Banba et al, ‘A CMOS Band-Gap Reference Circuit with Sub IV Operation’ 1998Symposium on VLSI Circuits Digest of Technical Papers, p.228 to 229.”

In these conventional techniques, it is necessary to add the PTAT current and CTAT current and pass it through a third current path to convert it from the current to the voltage. The current passing through the third current path is influenced by a change in V_{DS} of a MOS transistor for mirroring the current when the noise from power supply is added. A current value changes due to this influence, and PSRR deteriorates. Therefore, there is a problem that the PSRR and noise characteristic are worse than a typical 1.2 V output band-gap circuit. In addition, there are a large number of current paths, and so the number of elements as a whole increases and the noise and reference voltage variation amounts deteriorate.

An object of the present invention is to provide the band-gap circuit operable at the low supply voltage and capable of generating the low reference voltage, which further has high PSRR, low noise and few reference voltage variations.

### SUMMARY OF THE INVENTION

A band-gap circuit of the present invention has a first bipolar transistor, a second bipolar transistor, a first voltage control current source connected to an emitter of the first bipolar transistor, a second voltage control current source connected to the emitter of the second bipolar transistor, a feedback control amplifier for having voltages of the emitter of the first bipolar transistor and the emitter of the second bipolar transistor inputted respectively and controlling the first and second voltage control current sources to equalize emitter voltages of the first and second bipolar transistors, resistor divided into at least two and connected between a base and the emitter of the first bipolar transistor, and resistive elements connected between the base and a collector and between the base and emitter of the second bipolar transistor respectively so as to produce an output from a split node of the resistive element between the base and emitter of the second bipolar transistor.

In the band-gap circuit, emitter area of the second bipolar transistor may be N times (N is a positive integer) the emitter area of the first bipolar transistor.

Furthermore, it is possible to render current ratios of the first and second voltage control current sources different so as to render ratios of the currents passing through the first and second bipolar transistors different.

It is possible, by preparing such a band-gap circuit, to provide the band-gap circuit operable at the low supply voltage and having high PSRR, low noise and few voltage variations.

### BRIEF DESCRIPTION OF THE DRAWINGS

FIG. 1 is a diagram showing a low supply voltage band-gap circuit according to the conventional art.

FIG. 2 is a diagram showing the low supply voltage band-gap circuit according to the conventional art.

FIG. 3 is a diagram showing a first embodiment of the band-gap circuit according to the present invention.

FIG. 4 is a diagram showing the band-gap circuit in the case where noise exists in an input of an amplifier.

FIG. 5 is a diagram showing a second embodiment of the band-gap circuit according to the present invention.

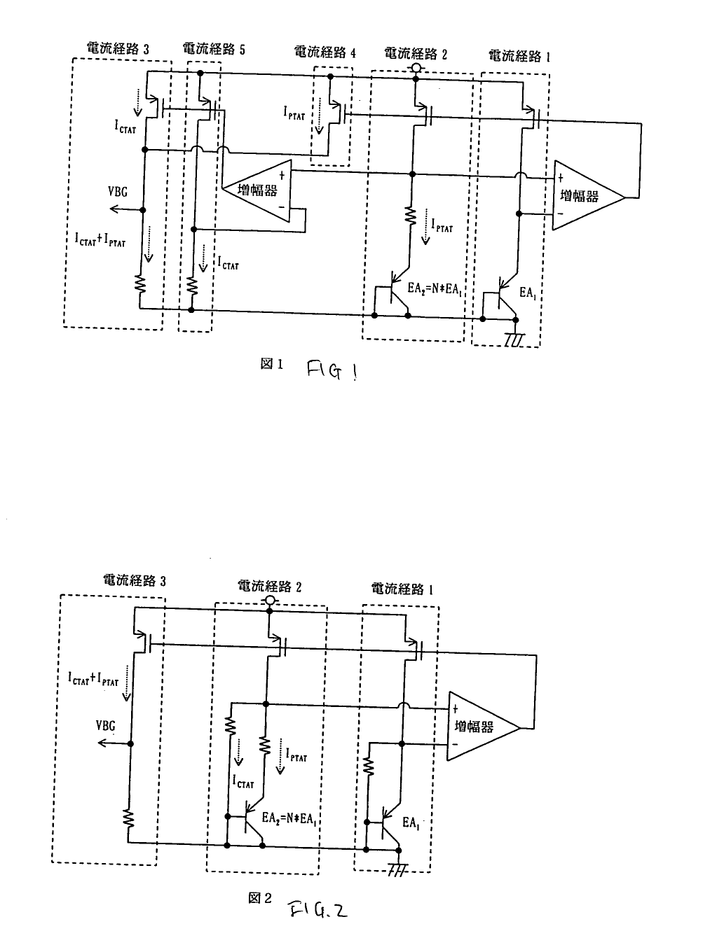

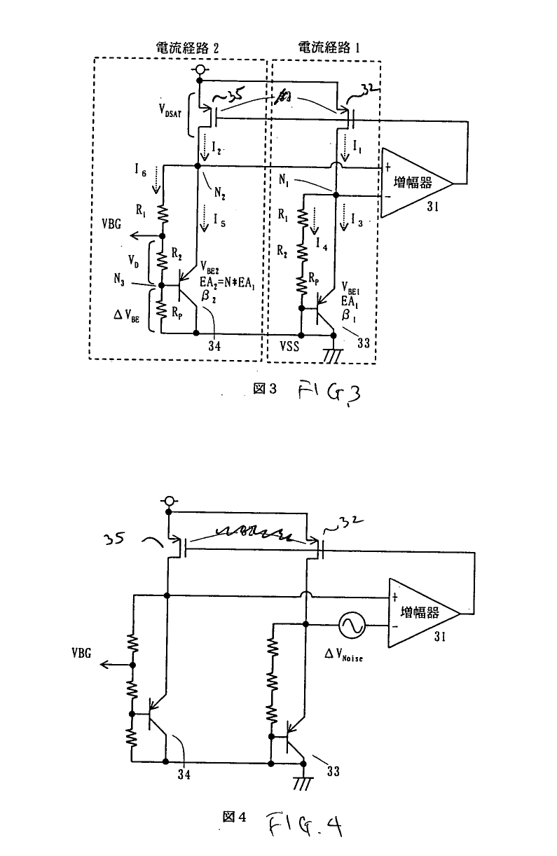

### DETAILED DESCRIPTION OF THE INVENTION

FIG. 3 is a diagram showing a band-gap circuit according to the present invention, where a current path 1 and a current path 2 are provided between a supply voltage and a ground voltage. The current path 1 is comprised of a PMOS transistor 32 and a bipolar transistor 33, where a source of the PMOS transistor 32 is connected to the supply voltage and a drain of the PMOS transistor 32 is connected to an emitter of the bipolar transistor 33. A collector and a base of the bipolar transistor 33 are connected to a ground potential. Furthermore, a resistor R1, a resistor R2 and a resistor Rp are connected in series between the emitter and base of the bipolar transistor 33.

The current path 2 is comprised of a PMOS transistor 35 and a bipolar transistor 34, where the source of the PMOS transistor 35 is connected to the supply voltage and the drain of the PMOS transistor 35 is connected to the emitter of the bipolar transistor 34. The collector of the bipolar transistor 34 is connected to the ground potential. Furthermore, the resistor R₁ and R₂ are connected in series between the emitter and base of the bipolar transistor 34. The resistor Rₚ is connected between the collector and base of the bipolar transistor 34.

The voltage of a connection node N₁ between the drain of the PMOS transistor 32 and the emitter of the bipolar transistor 33 in the current path 1 is connected to an inverting input terminal of a feedback control amplifier 31. The voltage of a connection node N₂ between the drain of the PMOS transistor 35 and the emitter of the bipolar transistor 34 in the current path 2 is connected to a non-inverting input terminal of the feedback control amplifier 31. Signals outputted from an output terminal of the feedback control amplifier 31 are inputted to gates of the PMOS transistors 32 and 35.

Characteristics of the two MOS transistors 32 and 35 are equal.

The feedback control amplifier 31 controls currents passing through the two current paths so that the potentials of the nodes N₁ and N₂ become equal. As the voltages between the gates and sources of the two MOS transistors 32 and 35 are constantly equal, currents I₁ and I₂ passing through the MOS transistors 32 and 35 respectively are constantly equal currents. As the potentials of the nodes N₁ and N₂ are equal, a voltage difference ΔV_{BE} between the base and emitter of the bipolar transistors 33 and 34 is the potential of the node N₃ and can be represented by a formula (1).

$$\begin{matrix}Δ {V}_{BE} = {V}_{BE1} - {V}_{BE2} \\ = {V}_{T} * ln ( {I}_{3} / {I}_{S} ) - {V}_{T} * ln ( {I}_{5} / ( N * {I}_{S} ) ) \\ = {V}_{T} * ln ( N * {I}_{3} / {I}_{5} )\end{matrix} \qquad ( 1 )$$

Here, V_{T} can be represented as V_{T}=kT/q by using a Boltzmann's constant k, an absolute temperature T and a electronic charge q. I_{S} is an saturation current of the bipolar transistor, and I₄ is the current passing through the resistor connected between the base and emitter of the bipolar transistor 33. I₅ is the emitter current of the bipolar transistor 34, and I₃ is the emitter current of the bipolar transistor 33, and I₆ is the current passing through the resistance connected between the base and emitter of the bipolar transistor 34. Emitter area EA₂ of the bipolar transistor 34 is N times the emitter area of the bipolar transistor 33.

Furthermore, I₁ is a sum of I₃ and I₄, I₂ is a sum of I₅ and I₆, and I₁=I₂ and so a formula (2) holds.
I₃+I₄=I₅+I₆ (2)

The potentials of the nodes N₁ and N₂ can be represented by a formula (3) using the currents I₄ and I₆ passing through the resistance, abase current I₅/(1+β₂) of the transistor 34 and the resistance values R₁, R₂ and Rₚ respectively. Here, β₂ is the current gain of the transistor 34.
Potential of N₁:(R₁+R₂+Rₚ) I₄
Potential of N₂:(R₁+R₂)I₆+Rₚ(I₆+I₅/(1+β₂)) (3)
Furthermore, the potentials of the nodes N₁ and N₂ are equal, and so a formula (4) holds.
(R₁+R₂)I₆+Rₚ(I₆+I₅/(1+β₂))=(R₁+R₂+Rₚ)I₄ (4)
From the formulas (2) and (4), a ratio between I₃ and I₅ can be represented by a formula (5).
I₃/I₅=1+Rₚ/((R₁+R₂+Rₚ)(1+β₂)) (5)
Accordingly, ΔV_{BE} of the formula (1) can be represented by using the formula (5) as in a formula (6).
ΔV_{BE}=V_{T}*ln(N(1+Rₚ/((R₁+R₂+Rₚ)(1+β₂)))) (6)

This is a PTAT voltage directly proportional to the temperature.

On the other hand, the voltage difference between the nodes N₂ and N₃ is the voltage V_{BE2} between the base and emitter of the bipolar transistor 34, and is a CTAT voltage which decreases as the temperature increases, as is known in the art. Accordingly, a voltage V_{D} between output nodes VBG and N₃ is the voltage having divided V_{BE2} by using the resistors R₁ and R₂, which can be represented by a formula (7). This is also the CTAT voltage inversely proportional to the temperature.
V_{D}=V_{BE2}*R₂/(R₁+R₂) (7)

An output reference voltage VBG is the voltage having added a potential V_{D} between the node N₃ and VBG which is the CTAT voltage and a potential ΔV_{BE} of the node N₃ which is the PTAT voltage. The resistors are adjusted to arbitrary resistance values so that the PTAT voltage and the CTAT voltage mutually counteract temperature dependency to output the reference voltage with no temperature dependency. The output reference voltage VBG at this time can be represented by using the formulas (6) and (7) as in the following formula (8), and is capable of outputting a low voltage proportional to a band-gap voltage.
VBG=V_{D}+ΔV_{BE}=V_{BE2}*R₂/(R₁+R₂)+V_{T}*ln(N(1+Rₚ/((R₁+R₂+Rₚ)(1+β)))) (8)

As is understandable from the formula (8), it is possible to set the reference voltage value at an arbitrary value by changing an emitter area ratio N of a PNP transistor. For instance, according to this embodiment, it is VBG˜0.2V when N=8 and VBG˜0.3V when N=56.

This circuit outputs the reference voltage from between the node N₂ which is stable as being feedback-controlled by an amplifier and a ground potential VSS. Therefore, it is not easily influenced by variations in the supply voltage so that it can improve PSRR in a low-frequency region, for instance, on the order of 30 dB compared to conventional techniques.

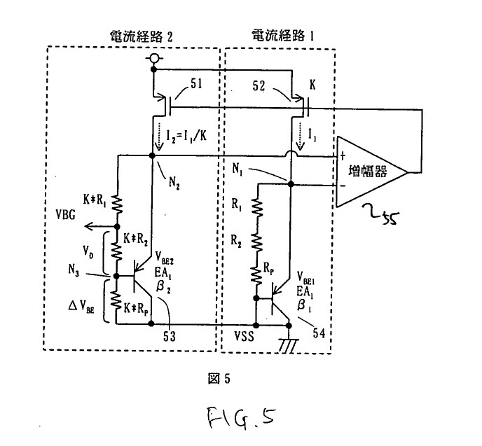

Next, consideration is given to influence of noise of the amplifier. As shown in FIG. 4, the output reference voltage VBG can be represented by using the formula (9) by using input-referred noise ΔV_{Noise} . . . (9)
VBG˜V_{BE2}*R₂/(R₁+R₂)+V_{T}*ln(N(1+Rₚ/((R₁+R₂+Rₚ)(1+β))))+ΔV_{Noise} (9)

As is understandable from the formula, a noise component is multiplied by 1 to be added to the VBG. The conventional band-gap circuit has the noise component amplified to a degree of above 1, which shows that the band-gap circuit of the present invention has a low noise characteristic. It is much the same for input-referred offset of the amplifier. The low noise and few variations in the output reference voltage are realized for the above reason and also because the number of the current paths is small and the number of transistors possibly causing the noise and voltage variations is also small.

On the other hand, a minimum supply voltage at which this circuit is operable can be represented by a formula (10) in general since the MOS transistor 32 needs to be operated in a saturation region.
VDD>V_{BE1}+V_{DSAT} (10)

Here, V_{DSAT} is a drain voltage necessary for the MOS transistors 32 and 35 to operate in the saturation region.

From the formula (10), it is possible to constitute the band-gap circuit capable of operation at the low supply voltage of 1V or less by using the MOS transistors with a low threshold voltage and the feedback control amplifier 31 capable of operation at the low supply voltage.

From the above, it is possible, by using the potential having divided V_{BE} as the CTAT voltage directly, to generate the low reference voltage having no temperature dependency and proportional to the band-gap voltage only in the two current paths so as to allow the operation at the low supply voltage. To be more specific, it is possible, as no third current path is required, to implement the high PSRR, low noise and few voltage variations.

The example was described as to the case of using a CMOS process. However, it goes without saying that it can also be implemented by using a bipolar process.

Next, the embodiment shown in FIG. 5 is different from the circuitry in FIG. 3 in that it is the circuit in which the ratio between gate width W and gate length L (W/L) of a current-source MOS transistor 52 is K times that of a MOS transistor 51 and the emitter area of a bipolar transistor 53 is equal to that of a bipolar transistor 54. If the currents to pass through the two current paths are controlled to equalize the potentials of the nodes N₁ and N₂, a relationship between the currents I₁ and I₂ passing through the two MOS transistors 51 and 52 in that case is I₂=I₁/K. Therefore, it is possible, by setting the resistances on the bipolar transistor 53 side at values K times those of the resistance values R₁, R₂ and Rₚ on the bipolar transistor 52 side, to induce a bias state like the band-gap circuit in FIG. 3 so as to output the low voltage proportional to the band-gap voltage having no temperature dependency as the output reference voltage VBG at this time. The output reference voltage value can be set at an arbitrary value by changing a ratio K between the gate width W and gate length L of the current-source MOS transistor, that is, changing the ratio of the currents passing through the two bipolar transistors.

What is claimed is:

1. A band-gap circuit having:
a first bipolar transistor;
a second bipolar transistor;
a first voltage control current source connected to an emitter of the first bipolar transistor;
a second voltage control current source connected to the emitter of the second bipolar transistor;
a feedback control amplifier for having voltages of the emitter of the first bipolar transistor and the emitter of the second bipolar transistor inputted respectively and controlling the first and second voltage control current sources to equalize emitter voltages of the first and second bipolar transistors;
a resistor divided into at least two and connected between a base and the emitter of the first bipolar transistor; and
resistors connected between the base and a collector and between the base and emitter of the second bipolar transistor respectively, and is characterized by:
producing an output from a split node of the resistor between the base and emitter of the second bipolar transistor.

2. The band-gap circuit according to claim 1, characterized in that emitter area of the second bipolar transistor is N times (N is a positive integer) the emitter area of the first bipolar transistor.

3. The band-gap circuit according to claim 1, characterized in that current ratios of the first and second voltage control current sources are different and ratios of the currents passing through the first and second bipolar transistors are different.
